(19) United States
(12) Patent Application Publication
(10) Pub. No.: US 2022/0166259 A1
(43) Pub. Date: May 26, 2022

(54) SYSTEM FOR GENERATING, TRANSMITTING AND DISTRIBUTING ELECTRICAL ENERGY

(71) Applicant: Yellow Sands Technologies, Ltd, Sderot (IL)

(72) Inventors: Motti Haridim, Givat Zeev (IL); Chaim Shine, London (GB)

(73) Assignee: Yellow Sands Technologies, Ltd, Sderot (IL)

(21) Appl. No.: 17/102,018

(22) Filed: Nov. 23, 2020

(51) Int. Cl. H02J 50/20

(52) U.S. Cl. CPC H02J 50/20

(57) ABSTRACT

A system for generating, transmitting and distributing electrical energy has a generator of electric energy, a convertor for converting the generated electric energy to microwaves, a transmitter for wirelessly transmitting the generated microwaves over a space without a microwave connection, a receiver for receiving the transmitted microwaves, and a converter for converting the received microwaves into electric energy to be supplied to consumers.

### BACKGROUND OF THE INVENTION

The present invention is generally related to systems for generating, transmitting and distributing electrical energy.

Systems for generating, transmitting and distributing electrical energy are known and widely used in modern life for multiple uses by corresponding consumers. Such systems usually include generators which generate electrical energy, electric current cables extending from the generators, and consumer electric current lines which extend from electric current cables to corresponding electric current consumers.

One of the problems of the existing systems for generating and transmitting electrical energy in the case of the locations of electric energy consumers at significant distances from the location of the electrical energy generators is that the electric energy carrying cables can have extremely great lengths and need pylons (every 200-300 m) with associated very high costs, and in many instances should extend through complicated terrains, such as under water, high over ground, or hard-to-access places.

### SUMMARY OF THE INVENTION

Accordingly it is an object of the present invention to provide a system for generating, transmitting and distributing electrical energy which eliminates the disadvantages of the prior art systems.

In keeping with these objects and with others which will become apparent hereinafter one feature of the present invention resides, briefly stated, in a system for generating, transmitting and distributing electrical energy which includes a generator of electric energy, a convertor for converting the generated electric energy to microwaves, means for wirelessly transmitting the generated microwaves over a space without a wire- or a cable microwave connection, means for receiving the transmitted microwaves, and means for converting the received microwaves into electrical energy to be supplied to consumers.

When the system for generating, transmitting and distributing electrical energy is designed in accordance with the present invention it avoids the disadvantages of the prior art since it eliminates continuous electric cables and pylons from the generators of the electric energy to the consumers of the electric energy.

In accordance with a further feature of the present invention the means for transmitting the generated microwaves is a moveable means, that is the generator and the transmitter are installed on a moveable means in air, sea or earth such as a drone, airplane, automobile and ship, while the means for receiving the microwaves is either static or moveable, and the transmitting means is equipped with a means for detecting and tracking a position of the receiving means. In this case, obviously the cable connection cannot be used, put aside the disadvantages.

In accordance with a further feature of the present invention the means for receiving the transmitted microwaves is a moveable means, while means for transmitting the microwaves over a space is operative for detecting and tracking a position of the moveable receiving means.

In accordance with a further feature of the present invention the means for transmitting microwaves is formed so that it uses a beam forming technique for detecting and tracking the location of the receiving means and using this information for directing the microwaves towards the moveable receiving means.

In accordance with a further feature of the present invention the moveable receiving means is a drone, or a helicopter, or an unmanned aerial vehicle, ad or a tropospheric platform, and alike.

In accordance with a further feature of the present invention the moveable receiving means include multiple receivers located in various directions and places, while the means for transmitting the microwaves include a transmitter capable of targeting the multiple receivers: either statically (power delivered simultaneously to all receivers), or the whole power delivered to each receiver—one at a time, or a combination of these two schemes.

In accordance with a further feature of the present invention the transmitter is operative for dynamically allocating an amount of power delivered to each receiver using information obtained from the receivers regarding their actual instantaneous demand—based on a preset allocation policy and priority scheme.

In accordance with a further feature of the present invention the generator of the electrical energy is operative for harvesting energy from a platform located on a sea/lake, carrying solar panels, sea waves energy harvesters, wind energy turbines and alike, and the transmitter is operative for transmitting energy from a combination thereof to a terrestrial object.

In accordance with a further feature of the present invention a repeater means is provided, operative for receiving and transmitting the microwaves in cases when a path between a source of the energy and a target for receiving the latter is not in a line of sight or where a distance between the transmitter and the receiver is too large.

The novel features of the present invention will be best understood from the following description of the preferred embodiments, which is accompanied by the following drawings.

### BRIEF DESCRIPTION OF THE DRAWINGS

FIG. 1 of the drawings is a view showing a system for generating, transmitting and distributing electrical energy in accordance with one embodiment of the present invention;

FIG. 2 of the drawings is a view showing a system for generating, transmitting and distributing electrical energy in accordance with another embodiment of the present invention;

FIG. 3 of the drawings is a view showing a-system for generating, transmitting and distributing electrical energy in accordance with a further embodiment of the present invention; and

FIG. 4 of the drawings is a view showing a system for generating, transmitting and distributing electrical energy in accordance with another embodiment of the present invention.

### DESCRIPTION OF THE PREFERRED EMBODIMENTS

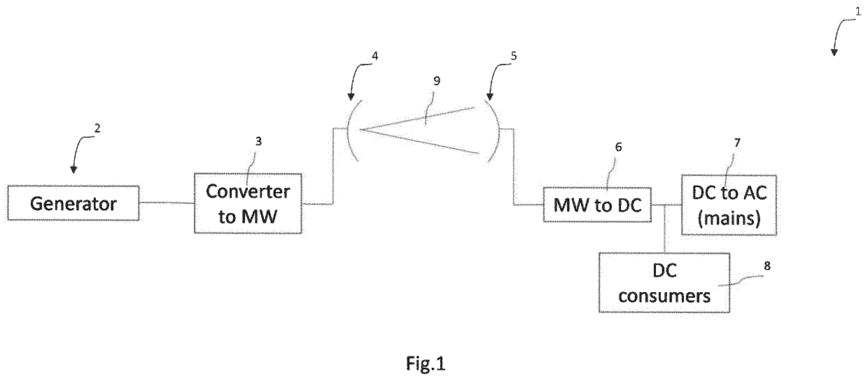

A system 1 for generating and transmitting electrical energy from a static point to another point and distributing the electrical energy according to one embodiment of the present invention is shown in FIG. 1. It includes a generator of electric energy, which is identified with reference numeral 2. It can be an electrical energy generator which generates an electrical energy from solar energy, from wind energy, from oil, from gas, from sea-waves, etc. or a combination of any number of them. Such electrical energy generators are known and have been used on many locations.

The system 1 further includes a converter 3 which converts the electrical energy generated by the generator 2 into microwaves. The microwaves produced in this manner are then transmitted through a transmitting directional antenna 4, that beams the power in a microwave beam 9 directed towards and collected by a receiving antenna 5.

The received microwaves from the receiving antenna 5 are further transmitted to a MW-to-DC converter 6. The converter 6 converts the received microwaves into an electrical energy in a form suitable for a target network, such as main electricity, electric grid, etc.

The converter 3 can be a DC electricity-to-microwaves converter in the case when the electrical energy source produces a DC electrical energy, to convert the DC to the microwaves. The converter 3 can be also an AC (conventional main) electricity to microwaves converter, or any other type of electrical power produced by the generator 2 to microwaves. The converter 6 can be a converter which converts the received microwaves to DC. The DC obtained after the conversion can be converted to AC by a converter 7 and supplied to AC consumers, or can be directly supplied to DC consumers 8. it is possible to combine antenna 5 with microwaves-to-DC converter 6 into one device commonly known as rectenna (a rectifier with an antenna)

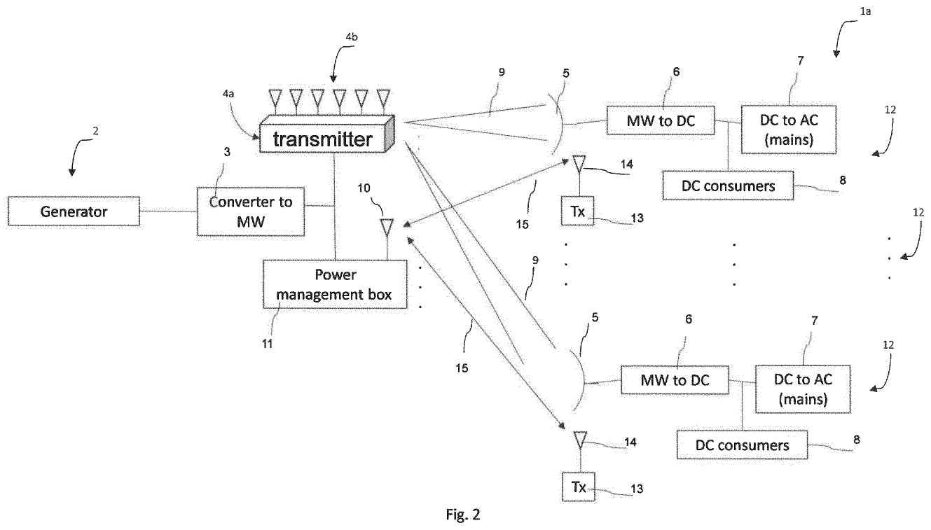

FIG. 2 shows another embodiment of a system 1b for generating, transmitting and distributing electrical energy according to the present invention, which is formed as a system for generating, point-to multipoint transmitting and distributing electrical energy. It includes a generator of electrical energy which is identified with reference to numeral 2. It can be an electrical energy generator which generates an electric energy from solar energy, from wind energy, from oil, from gas, from sea-waves etc. or a combination of any number of them. A converter 3 converts the electrical energy of any form (DC, AC, etc.) produced by the generator 2 into microwaves.

The microwaves produced in this manner are then wirelessly transmitted through a transmitter 4a and a group of antennas 4b The group of antennas 4b radiates several microwave beams 9, and directs each microwave beam 9 towards a receiving antenna 5 in a power receiving station 12. Each receiving antenna 5 collects the corresponding microwave beam 9.

The transmitter 4a is equipped with a group of antennas 4b each fed by a certain amount of power for transmitting it to a certain receiving antenna 5. The antennas 4b can be a group of independent antennas each radiating a narrow beam to a receiver, or a multi-beam antenna system that radiates several independent beams simultaneously.

The transmitter 4a can be also equipped with a means for on-line (dynamic) power allocation according to the instantaneous demand at each station and a predefined priority strategy. For this purpose, the transmitter is equipped with a power management means 11 that uses a group of receiving antennas 10 for communication with each power receiving station 12. The communication is done by a transmitting antenna 14 in each receiver 12 through a beam 15. An antenna 14 is fed by signals from a transmitter 13, the signals carrying on-line information regarding the amount of power requirements of the receiver 12 at any time. The power receiving station 12 may use antenna 5 also for communication instead of the transmitting antenna 14 with merging the two antennas in one. The power management module 11 receives-an on-line information from all N power receiving stations 12 and accordingly manages/adjusts the amount of the electrical power transmitted to each receiver.

The received microwaves from the receiving antennas 5 are further transmitted to MW-DC converters 6. The converter 6 can be a converter that converts the received microwaves into a DC electrical energy. The DC obtained after the conversion can be converted to AC by a converter 7 and supplied to AC consumers or can be directly supplied to DC consumers 8. It is possible to combine the antenna 5 with microwaves-to-DC converter 6 into one device commonly known as rectenna including a rectifier and an antenna.

The converter 3 is a DC electricity-to-microwaves converter in the case when the electrical energy source produces a DC electrical energy, to convert the-DC to microwaves. The converter 3 can be also an AC (conventional main) electricity to microwaves converter, or converting any other type of electricity produced by the generator 2 to microwaves.

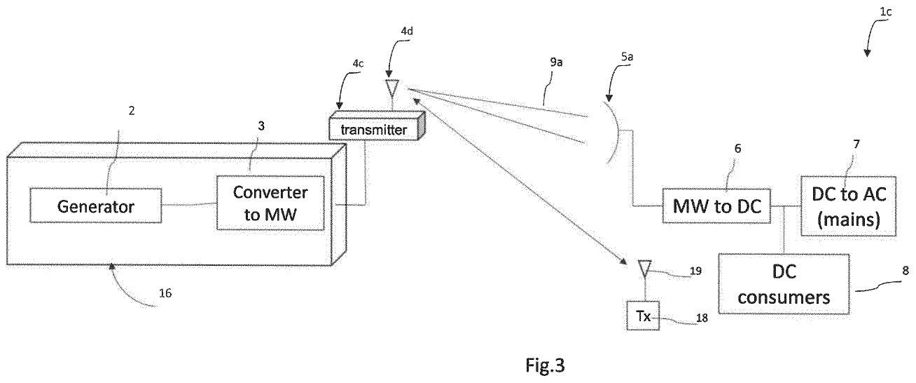

In accordance with a further feature of the present invention in a system for generating, transmitting and distributing electrical energy 1c of the invention the means for generating and transmitting microwaves is a moveable means (or installed on a moveable vehicle such as drone, plane, ship, automobile) and it transmits the microwaves to a stationary object as shown in FIG. 3. The power transmitting means 16 is carried by a moveable means that can be formed as, but not limited to, a drone, or a helicopter, or an unmanned aerial vehicle, or a tropospheric platform.

A generator 2 generating an electrical energy, a converter 3 for converting the generated electrical energy to microwaves, a transmitter 4c and a power transmitting antenna 4d and an antenna 4g detecting and tracking the position of the receiver, with an ability to detect, track the target receiving station and accordingly change a direction of the generated microwave beam 9a to be dynamically directed or steered to a desired stationary object are provided in the moveable means. Detection and tracking of the receiver can be done using a radar system or by a means for direction of arrival finding, or any beam forming technique. In the latter cases, the power receiving station can have a transmitter 18 (including at least one antenna 19) that transmits a signal in order to facilitate its detection and tracking by the transmitter. The signal is received by a separate antenna 4g in the transmitter or by the antenna 4d used for power transmission.

The microwaves beam 9a transmitted by the transmitting antenna 4d is received by a receiving antenna 5a of the stationary object. Antenna 5a can receive a power beam from different directions, depending on the position of the moveable transmitter. Similarly to the embodiment shown in FIG. 1, the received microwaves can be converted to DC in the converter 6, and then the obtained DC can be converted to AC in the converter 7, and also can be supplied directly to DC consumers.

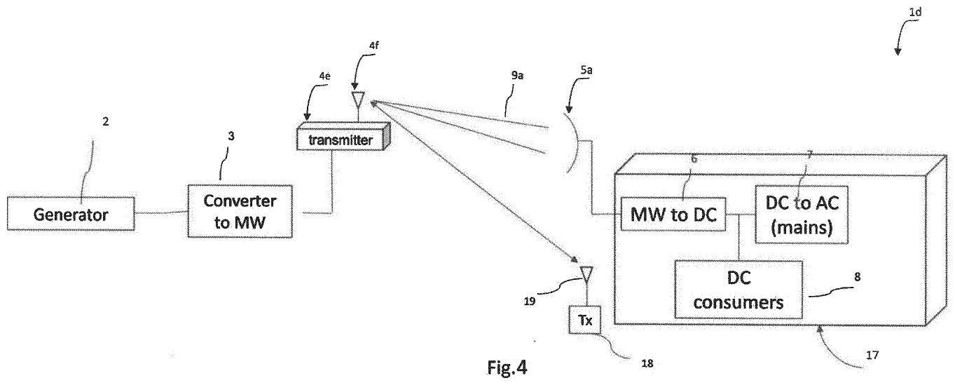

FIG. 4 shows a system 1d for generating electrical energy and transmitting it from a static object for example from a terrain station to a moveable object 17 such as for example a drone, or a helicopter, or an unmanned aerial vehicle, or a space (e.g. tropospheric) platform. In this system the generator of the electrical energy 2 and the converter of the electrical energy 3 into microwaves are associated with a stationary station, for example they are arranged on a terrain station or a sea platform. A transmitter 4e has a transmitting antenna 4f that transmits the beam 9a of the generated microwaves to a moveable power receiving means 17.

Detection and tracking of the receiver can be done using a radar system or by a means for direction of arrival finding or any beam forming technique. In the latter case, the power receiving station 17 can have a transmitter 18 (including at least one antenna 19) that transmits a signal in order to facilitate its detection and tracking by the transmitter. The signal is received by a separate antenna 4g in the transmitter or by the antenna 4e used for power transmission. A receiving antenna 5a of the stationary object 17 receives the transmitted microwaves. A converter MW to DC 6 converts the received microwaves into DC, which can be then converted by a converter 7 to AC or supplied directly to DC consumers 8.

The novel features of the present invention will be best understood from the following description of the preferred embodiments, which is accompanied by the following drawings.

1.-3. (canceled)

4. A system for generating, transmitting and distributing electrical energy of claim 11, wherein the means for transmitting microwaves is formed so that it uses a beam forming technique for directing the microwaves towards the receiving means.

5. A system for generating, transmitting and distributing electrical energy of claim 11, wherein the means for transmitting microwaves is movable and uses a beam forming technique for directing the microwaves towards the microwaves receiving means.

6. A system for generating, transmitting and distributing electrical energy of claim 11, wherein the moveable microwaves receiving means is formed as a drone, or a helicopter, or an unmanned aerial vehicle, or a tropospheric platform.

7. A system for generating, transmitting and distributing electrical energy of claim 11, wherein the moveable microwaves receiving means include multiple receivers located in various directions and places, while the means for transmitting the microwaves include a single transmitter targeting the multiple receivers.

8. A system for generating, transmitting and distributing electrical energy of claim 11, wherein a transmitter of each of the microwaves transmitting means is operative for dynamically allocating power delivered to each receiver of the microwaves receiving means using information obtained from the receivers regarding their actual instantaneous demand.

9. A system for generating, transmitting and distributing electrical energy of claim 11, wherein the generator of the electric energy is operative for harvesting from a sea solar energy, a sea waves energy, and a wind turbine energy, and a transmitter of the microwaves transmitting means is operative for transmitting a combination thereof to a terrestrial power receiving station of the means for receiving the microwaves.

10. A system for generating, transmitting and distributing electrical energy of claim 11, further comprising repeater means operative for transmitting the microwaves from the microwaves transmitting means in cases when a path between a source of the energy and a target for receiving the latter is not in a line of sight.

11. A system for generating, transmitting and distributing electrical energy, comprising
a generator operative for generating an electrical energy from p static object, a sea solar energy, a sea wave energy, and a wind turbine energy;
a convertor for converting into microwaves the electric energy generated by the generator from the static object, the sea solar energy, the sea wave energy, and the wind turbine energy;
static or moveable means for wirelessly transmitting from the converter the microwaves generated from the static object, the sea solar energy, the sea wave energy, and the wind turbine over a space without a wire/cable connection;
static or moveable means for receiving the transmitted microwaves; and
means for converting the received microwaves into electrical energy to be supplied to consumers.

12. A system for generating, transmitting and distributing electrical energy of claim 11, wherein the system is formed to use a smart antenna technique for finding an exact position of a receiver at any instance and for concentrating a microwave beam in a very narrow pencil-like beam, with these two features being achieved by methods of direction finding or estimation of an angle of arrival, using a two-dimensional or a three-dimensional array of antennas at both sides—a transmitter and a receiver.

13. A system for generating, transmitting and distributing electrical energy of claim 12, wherein a mechanical rotating means is used in addition to an electrical beam steering in a hybrid system, i.e. both mechanical and electrical beam steering means, and transmitting and/or receiving antenna arrays are installed on a mechanically moveable rotational antenna such as a reflector dish so that this will help to achieve the two above mentioned tasks, namely estimation of the angle of arrival and the pencil-like microwave beam with better efficiency and smaller transmitters and receivers.

14. A system for generating, transmitting and distributing electrical energy of claim 11, wherein an independent a-priory known information regarding a “rough” position of a moveable side, either a transmitter or a receiver, in case it is known, is used in angle of arrival and beamforming algorithms.
